(19) United States
(12) Patent Application Publication
(10) Pub. No.: US 2025/0097100 A1
(43) Pub. Date: Mar. 20, 2025

(54) SYSTEM AND METHOD FOR SELECTIVE PROVISIONING OF NETWORK RESOURCES

(71) Applicant: Alkira, Inc., San Jose, CA (US)

(72) Inventors: Moiz Raja, Dublin, CA (US); Amit Mandke, San Jose, CA (US)

(21) Appl. No.: 18/892,133

(22) Filed: Sep. 20, 2024

Related U.S. Application Data
(60) Provisional application No. 63/584,139, filed on Sep. 20, 2023.

(51) Int. Cl. H04L 41/0806

(52) U.S. Cl. CPC H04L 41/0806

(57) ABSTRACT

A system and a method may be provided for selective provisioning of network resources. The system receives a request comprising a provisioning instruction for a set of network resources of a network. The network comprises a plurality of network resources, wherein the set of the network resources from the plurality of network resources is associated with a service provider. The system validate the provisioning instruction relating to the set of network resources based on a draft snapshot relating to the set of network resources, and cause to selectively provision the set of network resources from the plurality of network resources of the network based on the validation and the provisioning instruction. The selective provisioning of the set of network resources is performed based on service provider data of the service provider associated with the set of network resources.

### TECHNOLOGICAL FIELD

The present disclosure generally relates to provisioning of network resources, and more particularly it relates to selective provisioning of network resources of a network.

### BACKGROUND

Network Provisioning is a process of setting up a network so that authorized users, devices, and servers can access it. For example, network provisioning comprises provisioning of network resources of a network. However, a key challenge in network provisioning is related to networks having a large number of network resources and many users connected to the various network resources. In such a case, network provisioning becomes complex and time-consuming. Moreover, the provisioning of the various network resources together may lead to incorrect provisioning and communication interruptions.

### BRIEF SUMMARY

The present disclosure may provide a system and a method for selective provisioning network resources of a network.

In one aspect, a system for selectively provisioning network resources of a network is provided. The system comprises a memory configured to store computer executable instructions and one or more processors configured to execute the instructions. The processors are configured to receive a request comprising a provisioning instruction for a set of network resources of a network. The network comprises a plurality of network resources, wherein the set of the network resources from the plurality of network resources is associated with a service provider. The processors is configured to validate the provisioning instruction relating to the set of network resources based on a draft snapshot relating to the set of network resources and cause to selectively provision the set of network resources from the plurality of network resources of the network based on the validation and the provisioning instruction. The selective provisioning of the set of network resources is performed based on service provider data of the service provider associated with the set of network resources.

In additional system embodiments, the processors are further configured to output a network architecture indicating a node-level view of the set of network resources having updated provisioning information based on the selective provisioning.

In additional system embodiments, the network provides a service including at least one of: a software as a service (SaaS), an infrastructure as a service (IaaS), a platform as a service (PaaS), or a virtual network.

In additional system embodiments, the processors are further configured to generate an architecture of the set of network resources based on the provisioning instruction, capture a current snapshot of the generated architecture, validate an integrity of the provisioning instruction for the set of network resources by overlaying the current snapshot over a draft snapshot based on the previous draft snapshot of the set of network resources.

In additional system embodiments, the processors are further configured to identify one or more configuration changes for the set of network resources based on the overlaying of the current snapshot over the draft snapshot, and selectively provision the set of network resources of the network based on the one or more configuration changes based on the validation.

In additional system embodiments, the processors are further configured to receive one or more requests comprising corresponding provisioning instructions for corresponding one or more sets of network resources. The one or more sets of network resources are associated with corresponding one or more service providers. The processors are further configured to generate a request queue for storing the one or more requests, the request queue indicating a status for each of the one or more requests.

In additional system embodiments, the processors are further configured to cause selective provisioning of the provisioning instructions of the one or more requests during different time periods.

In another aspect, a method for selectively provisioning network resources of a network is provided. The method comprises receiving a request comprising a provisioning instruction for a set of network resources of a network. The network comprises a plurality of network resources, wherein the set of the network resources from the plurality of network resources is associated with a service provider. The method further comprises validating the provisioning instruction relating to the set of network resources based on a draft snapshot relating to the set of network resources. The method further comprises causing to selectively provision the set of network resources from the plurality of network resources of the network based on the validation and the provisioning instruction. The selective provisioning of the set of network resources is performed based on service provider data of the service provider associated with the set of network resources.

### BRIEF DESCRIPTION OF THE DRAWINGS

Having thus described example embodiments of the disclosure in general terms, reference will now be made to the accompanying drawings, which are not necessarily drawn to scale, and wherein:

FIG. 1 illustrates a block diagram of a network resource associated with a network, in accordance with an embodiment of the present disclosure;

FIG. 2 illustrates a block diagram of an example cloud exchange point (CXP), in accordance with an embodiment of the present disclosure;

FIG. 3 illustrates a block diagram of a plurality of regional services exchange points (RSXPs) stitched together to form the network, in accordance with an embodiment of the present disclosure;

FIG. 4 illustrates a block diagram of an example aggregated cloud services provisioning system, in accordance with an embodiment of the present disclosure;

FIG. 5 illustrates a block diagram of the network resource, in accordance with an embodiment of the present disclosure;

FIG. 6 illustrates a block diagram that shows a service infrastructure connected to the network using the cloud exchange point, in accordance with an example embodiment of the present disclosure;

FIG. 7 illustrates a block diagram of a system implemented for causing selective provisioning of a set of network resources in the network, in accordance with an example embodiment of the present disclosure;

FIG. 8 illustrates a flowchart of a method for causing selective provisioning of a set of network resources in the network, in accordance with an example embodiment of the present disclosure;

FIG. 9 illustrates an example network architecture of a network of an enterprise, in accordance with an embodiment; and

FIGS. 10A, 10B, 10C, and 10D collectively illustrate an example process of selective provisioning of network resources, in accordance with an example embodiment of the present disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems and methods are shown in block diagram form only in order to avoid obscuring the present disclosure.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced item. Moreover, various features are described which may be exhibited by some embodiments and not by others. Similarly, various requirements are described which may be requirements for some embodiments but not for other embodiments.

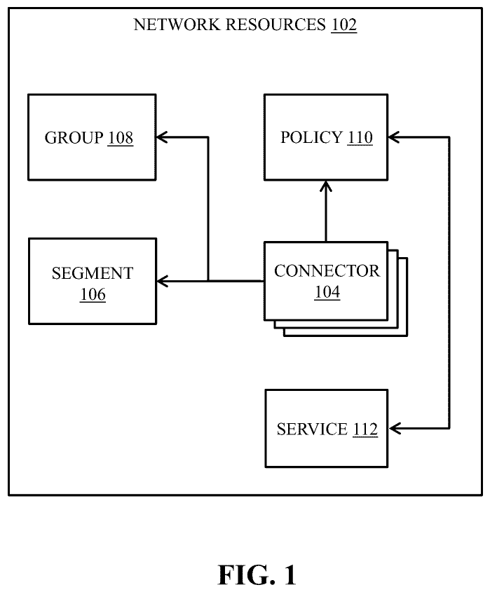

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect. Turning now to FIG. 1-FIG. 10, a brief description concerning the various components of the present disclosure will now be briefly discussed. Reference will be made to the figures, showing various embodiments of a system for providing a user with an interactive map.

Embodiments of the present disclosure provide a system and a method for enabling selective provisioning of certain network resources within a network. Typically, provisioning of network resources may include, for example, defining a manner in which two network endpoints or two end network resources, such as a router or a virtual machine of two networks may interact with each other. Besides connectivity, provisioning of network may also include provisioning a service or a chain of service in a network path, such as provisioning a firewall service on network resources within a network to allow or deny network traffic from going from one endpoint to another depending on policies.

The provisioning of the network resources for connectivity and services, including creation, configuration, and management of the network, is essential for ensuring that the network operates efficiently and effectively. The provisioning of the network resources is performed through manual and automated processes that involve allocating bandwidth, storage, and other network resources based on a requirement of a user of the respective network resources.

Conventionally, approaches for provisioning of network resources involve provisioning of all of network resources based a desired configuration of the network. This may cause unwanted changes in configuration of certain network resources that may not require provisioning or may have to be provisioned differently. Also, the provisioning of the network resources is highly complex and relies on integrity of a configuration of certain network resources to be provisioned provided by a user. Therefore, provisioning of the network resources may fail when there is a misconfiguration in the configuration provided by the user. To ensure integrity of the network, reliable and accurate provisioning of the network resources may become critical.

FIG. 1 illustrates a block diagram of a network resource 102 associated with a network, in accordance with an embodiment. The network resource 102 may include a connector 104, a segment 106, a group 108, a policy 110, and a service 112. For example, the network resource 102 may be a router, a switch, a gateway, a bridge, a hub, a modem, a repeater, an access point, a VPN, an antivirus, an anti-malware, a firewall etc.

The connector 104 of the network resource 102 may be a physical or logical link that is used to connect various other network resources. The connector 104 may be utilized to enable transmission and/or receptions of data between the various network resources. The connector 104 may be of any forms, such as wired connector and/or wireless connector that may use different protocols to facilitate communication or transfer of data between the network resources. For example, the wired connector may use Ethernet or universal serial bus (USB) protocols to transmit and/or receive the data. In other hand, the wireless connector may use wireless fidelity (Wi-Fi) or Bluetooth protocols. In addition to that the connector 104 may also be used to enable a device configuration or management, establishing security protocols etc.

The segment 106 may refer to a portion of the network that is separated from the rest of the network by the network resource 102. For example, a router may be used to create a network segment or segment 106 by dividing the network into different subnets. In one embodiment, the segment 106 may be utilized to improve performance of the networks resource 102 by reducing network congestion. For example, the segment 106 may be utilized to reduce the amount of an amount of traffic on the network by separating different types of the traffic onto different segments. In an example, various segments within the network may be generated based on regions. In another example, various segments within the network may be generated based on different service providers providing network resources of corresponding portion of the network.

In another embodiment, the group 108 may be a collection of computing devices or users that are grouped together for a specific purpose or for operating on a specific portion of the network, as provided by the network resource 102. The group 108 is used to simplify network administration by allowing a network administrator to manage multiple device or the users connected to the network resource 102 as a single entity.

The policy 110 may include a set of rule or guidelines that define the management of the network resource 102. The policy 110 are enforced to enhance the security, control access to the network resource 102, and ensuring compliance with regulation and best practices. For example, the policy 110 may define a type of traffic that is allowed to enter or leave the network, ports or protocols permission, authentication of the users etc. through the network resource 102. In addition to that, the policy 110 may be utilized by the administrator to manage and optimize the network resource 102 by prioritizing, limiting or restricting the usage of certain types of the traffic or applications.

Further, the service 112 may include various facilities provided based on the policy 102. For example, the service 112 can be provided by various providers, such software-as-a-service (SaaS) based providers, infrastructure-as-a-service (IaaS) based providers, platform-as-a-service (PaaS) based providers, etc. The service 112 is typically delivered using standardized protocols and communication method. For example, hypertext transfer protocol (HTTP) is used to provide web services. In an example, the network resource 102 may be used by computing devices to access the services 112.

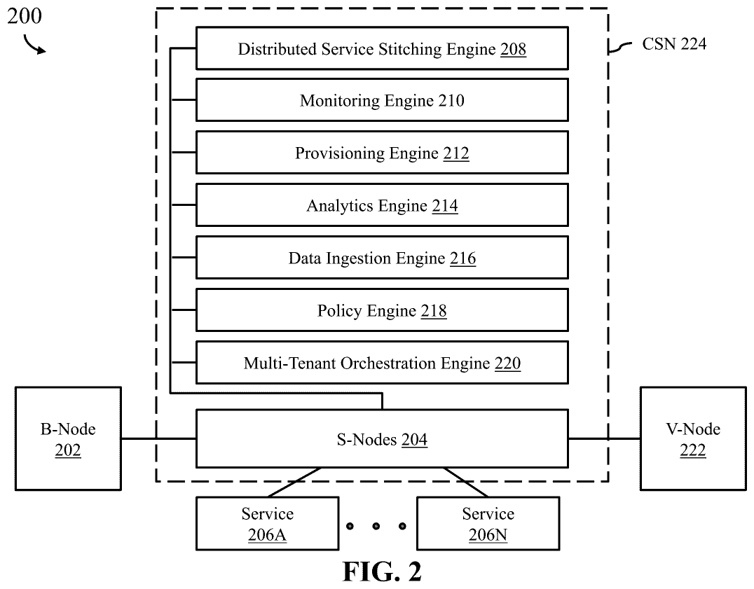

FIG. 2 illustrates a block diagram of an example cloud exchange point (CXP) 200, according to an example embodiment. The CXP 200 includes a B-node 202, an S-nodes 204 coupled to the B-node 202, a plurality of service engines depicted as service engines 206A-206N (collectively referred to as services 206) coupled to the S-nodes 204, and a V-node 222.

The CXP 200 refers to a system that establishes connectivity, instantiates services for corresponding geolocations, aggregates data, implements policies, monitors traffic, and/or provide analytics across disparate cloud service providers (CSP) and different connectivity architectures. In an example, the CXP 200 operates in a connectivity agnostic and cloud provider agnostic manner for a customer of the CXP 200. The CXP 200 may correspond to aggregated services, such as services 112 offered for a given region or a set of regions, where the regions may comprise one or more zones corresponding to sub-sections of such regions. The CXP 200 may service the branch network or the segment 106 within a particular region, and multiple CXPs may be stitched together as part of a larger cloud servicing network (e.g., mesh network, hub-and-spoke network, or a network having some other topology) to span multiple regions. For example, the CXP 200 provides a portal through which a network administrator or other user associated with a customer may, for example, view and select SaaS/IaaS/other services from a range of service providers (or provided by the customer itself) within a common dashboard, manage connectivity (e.g., MLPS, SD-WAN, IPsec, etc.), monitor traffic, control traffic in accordance with one or more policies (e.g., security policies), etc.

In an example, the B-Node 202 refers to an engine that couples a branch network to the CXP 200. For example, the B-node 202 is responsible for branch-to-cloud traffic. For example, the branch network is intended to represent a campus, site, data center, or other branch network under the control of a customer. In a specific implementation, the B-node 202 creates an overlay to connect a network branch or the segment 106 of the network having network resources of the group 108 to the cloud. Data traffic originating from the branch network within a given region may be controlled, managed, observed, and evaluated by the CXP 200. In certain cases, the customer, or a human or artificial agent associated with the branch network, such as managing the branch network, or a portion thereof, may access a single portal to select one or more of the services 206 (also represented as service 112 in FIG. 1) in connection with a software as a service (SaaS), infrastructure as a service (IaaS), or platform as a service (PaaS) offering. In a specific implementation, the B-node 202 (potentially including other B-nodes, not shown) connects the CXP 200 to multiple different branch networks.

The S-nodes 204 may represent multi-tenant node engines adapted to orchestrate the instantiation, hosting, and/or provisioning of the services 206 (selected via a portal accessible in association with the CXP 200) to one or more endpoints on behalf of a customer. The S-nodes 204 may host services 206 and apply policies 110 that might otherwise only be available through other cloud platforms, in other regions or otherwise only available with certain connectivity. For instance, if a customer using a cloud platform ‘A’ desired certain security features provided by a Firewall service ‘X’ that was only available through a cloud platform ‘B’, the S-nodes 204 may, via an orchestration component, host the Firewall service ‘X’ for the customer so that the customer may obtain the service as though they were using cloud platform ‘B’. Even if a customer uses different cloud platforms or has different connectivity throughout different segments, such as the segment 106 of its network, the CXP 200 may provide the foregoing features (e.g., monitoring traffic, managing connectivity, etc.) within a same dashboard interface for different cloud platforms. In a specific implementation, to effectuate these features, all data traffic is routed through the S-nodes 204.

The S-nodes 204 may send/receive traffic to and from networks implementing any type of connectivity (e.g., MPLS, SD-WAN, IPsec, etc.) and host services 206 from any one or more service providers so that the connecting networks may receive the benefit of those services without the hassle of reconfiguring their network to adapt to the service provider's requirements. The S-nodes 204 may instantiate such services 206 automatically upon request, so that an individual user associated with or connected through the branch network does not have to instantiate the services 206 themselves. The S-nodes 204 may collect telemetry data (e.g., to share with a multi-tenant orchestrator component), may tie the data flow to an application once packet details have been determined, may conduct analytics (e.g., statistical analysis) on data flow on a tailored basis (e.g., one in every ten packets received may be subjected to a deep packet inspection routine), and may tag or add instructions to packets for execution at a workload.

The CXP 200 further comprises a distributed service stitching (DSS) engine 208 coupled to the S-nodes 204, a monitoring engine 210 coupled to the S-nodes 204, a provisioning engine 212 coupled to the S-nodes 204, an analytics engine 214 coupled to the S-nodes 204, a data ingestion engine 216 coupled to the S-nodes 204, a policy engine 218 coupled to the S-nodes 204, a multi-tenant orchestration (MTO) engine 220 coupled to the S-nodes 204, and a V-node 222 coupled to the S-nodes 204. Further, the V-Node 222 is intended to represent an engine that couples the CXP 200 to a VPC. The VPC may relate to a Software as a service (SaaS), Infrastructure as a service (IaaS), Platform as a service (PaaS), or virtual network (V-net). In an example, the V-node 222 may enable cloud-to-cloud traffic. For example, the V-node 222 (potentially including other V-nodes, not shown) connects the CXP 200 to different clouds.

The DSS engine 208, the monitoring engine 210, the provisioning engine 212, the analytics engine 214, the data ingestion engine 216, the policy engine 218, the MTO engine 220, and the S-nodes 204 may collectively form and may be referred to as a cloud services node (CSN) 224.

The DSS engine 208 may be configured to stitch together (i.e. provide coherent communication, coordination, and connection to) one or more S-nodes associated with a plurality of CXPs associated with a respective plurality of different regions. In an example, the DSS engine 208 is configured to enable services from other regions (other CXPs) to be properly hosted in a region with which the S-nodes 204 are associated in order to satisfy one or more restrictions or regulations of a service/application. The DSS engine 208 may operate to establish a mesh network, a hub and spoke network, or any other applicable network distribution paradigm, or a combination of these between the CXPs of different regions by connecting corresponding S-nodes.

The monitoring engine 210 may be configured to inspect data packets passed to the S-nodes 204 and identify attributes about individual packets or groups of packets. Examples of the attributes of a data packet may include, but is not limited to, header information that may be used to identify a source, destination, or application/service relevant to the data packet.

The provisioning engine 212 may be configured to facilitate provisioning of one or more of the services 206 responsive to a request therefor. In certain cases, the S-nodes 204 are configured to host the requested service itself, enabling the customer to access the service through its connection to the S-nodes 204, without having to establish connectivity with the service provider or having to be connected to a service provider's platform.

The analytics engine 214 may be configured to obtain data from data ingestion engine 216 (which is configured to receive data from network elements and/or endpoints, and collect telemetry) and provide data analytics corresponding to, for example, traffic coming into the S-nodes 204, corresponding services 206 being used in connection with the S-nodes 204 throughout a connected network, connectivity issues within a network, and the like. Further, the policy engine 218 is configured to apply the policy 110 at the S-nodes 204. For example, the policy 110 is identifiable from a user request for the policy to be applied to a given flow of traffic. In an example, the policy 110 may be applied without requiring the customer to instantiate a service that applies the policy 110.

The MTO engine 220 is configured to automatically instantiates one or more of the services 206, which may be available across a series of CSNs, to multiple tenants without requiring manual instantiation by the tenants. The one or more services may be selected by the tenants for instantiations. In an example, the MTO engine 220 is SaaS-based. In certain cases, orchestration features provided by the MTO engine 220 may be provided as a wrapper around a third-party service, such as where the MTO engine 220 is integrated directly within a third-party service, in a transparent or apparent manner. In such cases, only certain features of a particular service that are supported by the CSN 224 may be shown. To this end, the orchestration provided by the MTO engine 220 may be offered as a distinct SaaS in addition to other third-party services.

In an example, the CSN 224 may include a collection of engines associated with the S-nodes 204. In another example, the CSN 224 may be incorporated within the one or more S-nodes 204. In yet another example, the services 206 are also incorporated within the CSN 224 (or one or more S-nodes).

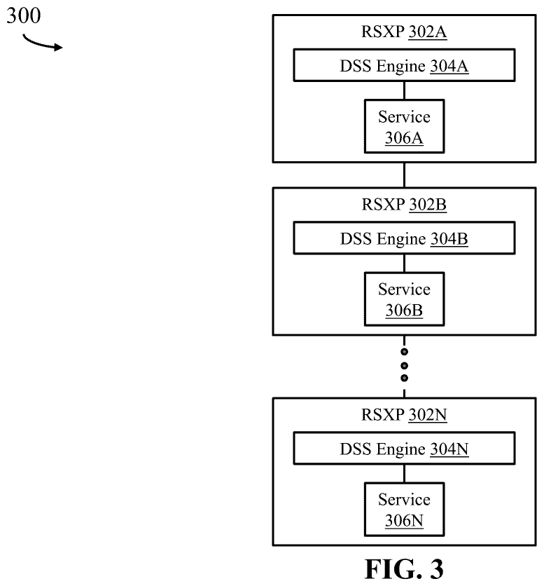

FIG. 3 illustrates a block diagram 300 of a plurality of regional services exchange points (RSXP) stitched together to form a network, according to an example embodiment. The diagram 300 includes a plurality of RSXPs depicted as RSXPs 302A, RSXP 302B, . . . , 302N (collectively referred to as RSXPs 302, hereinafter). The RSXP 302A includes a DSS engine 304A, the RSXP 302B includes a DSS engine 304B, and the RSXP 302N includes a DSS engine 304N. The DSS engines 304A, 304B, . . . , 304N are collectively referred to as DSS engines 304. Further, the RSXP 302A includes a service 306A, RSXP 302B includes a service 306B, and the RSXP 302N includes a service 306N. The services 306A, 306B, . . . , 306N are collectively referred to as services 306. It may be noted that the services 306 are depicted as coupled to the DSS engines 304 for conceptual purposes, but it should be understood the services could be coupled to corresponding S-nodes, such as the S-nodes 204.

The RSXPs 302 may include the corresponding DSS engines 304 and may be associated with different geographic, geopolitical, national, or other regions. The DSS engines 304 act as a single engine with respect to each of the services 306 regardless of the region in which the services 306 are found. The RSXPs 302 together form a network providing the services 306. For example, the services 306 may be provided by a service provider. In such case, the network comprising the RSXPs 302 may be hosted by the service provider of the services 306.

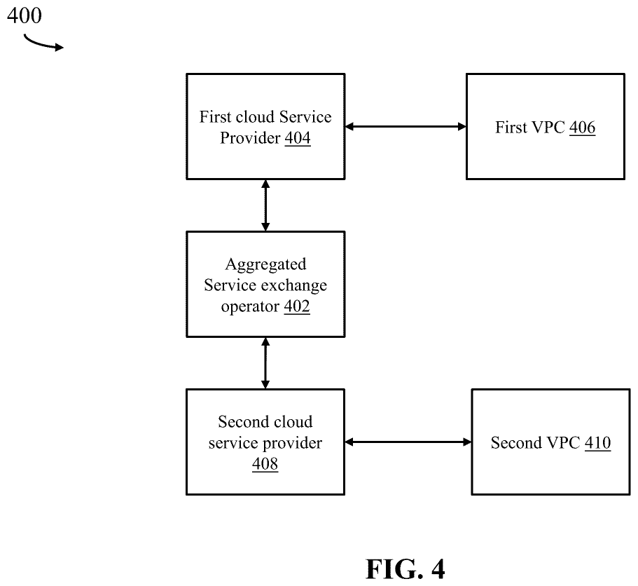

FIG. 4 illustrates a block diagram of an example aggregated cloud services provisioning system 400, according to an example embodiment. The cloud services provisioning system 400 includes an aggregated service exchange operator (ASEO) engine 402, a first cloud service provider 404 coupled to the ASEO engine 402, a first VPC 406 coupled to the first cloud service provider 404, a second cloud service provider 408 coupled to the ASEO engine 402, and a second VPC 410 coupled to the second cloud service provider 408. It an example, the ASEO engine 402 may be associated with a network infrastructure of, for example, a user, an organization, or an enterprise. For example, the ASEO engine 402 may enable the user to use services provided by the first cloud service provider 404 and the second cloud service provider 408. For example, the service provided by the first cloud service provider 404 and/or the second cloud service provider 408 may relate to, for example, communication, navigation, search and analytics, SaaS, IaaS, PaaS, etc.

In an example, a network infrastructure of a user may include one or more networks having a plurality of network resources. For example, the user may access and/or use different services from different service providers. Subsequently, the plurality of network resources in the one or more networks used by the user may belong to the different service providers. For example, if the user levies service from a cloud service provider providing SaaS and a cloud service provider providing IaaS and another cloud service provider providing another IaaS, then the network infrastructure (or network) of the user may include a first set of network resources relating to the SaaS, a second set of network resources relating to the IaaS and a third set of network resources relating to the other IaaS. For example, different network resources from the plurality of network resources may be associated with services from corresponding service provider.

The ASEO engine 402 aggregates services provided via the first cloud service provider 404 and the second cloud service provider 408 and makes the first VPC 406 and the second VPC 410 available through a common platform to a common customer base. In a specific implementation, the ASEO operator engine 402 is coupled to more than two cloud service providers (not shown).

Conventional provisioning methods enable provisioning of different network resources of different service providers at once. To this end, the conventional provisioning methods may fail to enable provisioning of only a portion of the network of the user, i.e., only certain network resources from the plurality of network resources. For example, if different developers working on the different services hosted on different network resources may request for provisioning of corresponding used services, then a network designer or network administrator may have to provision network resources based on the requests from different developers at once. For example, in cases where knowledge of network administrator is limited to a data or services relating to a particular service provider, the provisioning of the network resources based on the requests may be prone to misconfigurations as the integrity of the provisioning is dependent on a configuration of the network generated by the developer. In cases of misconfigurations of the network, services provided by certain service provider may be disrupted, thereby making the network prone to security threats, attacks, malpractice, etc.

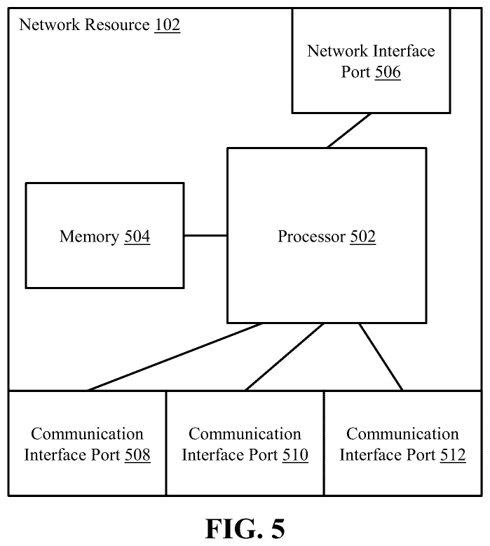

FIG. 5 illustrates a block diagram of a network resource 102, in accordance with an embodiment. The network resource may be associated with a service provider for providing a service to a user. The network resource 102 includes a processor 502 operatively coupled to a memory 504, a network interface port 506, a communication interface port 508, a communication port 510, and a communication port 512. The processor 502 is configured to communicate with computing devices such as host devices (e.g., servers in a network of the service provider) and virtual resources hosted by host devices via communication interface port 508, the communication interface port 510, and the communication interface port 512. In some embodiments, the network resource 102 may include more or fewer communication interface ports than are illustrated in FIG. 5. The network resource 102 may include, for example, 64, 128, 256, or more communication interface ports.

In an example, the network resource 102 is configured to receive data packets and forward the data packets to one or more of the network interface port 506 and/or the communication interface ports 508, 510 and 512, based on parameters of the data packets. For example, a data packet received via the network interface port 506 may include a destination parameter having a value associated with an identifier of a computing device connected to any one of the communication interface ports 508, 510 and 512, say port 508. The processor 502 may determine to which communication interface port, if any, the packet should be forwarded based on, for example, data stored in memory 504. Because the data packet includes a destination parameter having a value associated with an identifier of a computing device connected to the communication interface port 508, the processor 502 may determine that the data packet should be forwarded to the communication interface port 508. In an example, the memory 504 may include rules and/or ACLs (provided as provisioning instructions from a management entity via a network management module that are satisfied by parameters of the data packet before the processor 502 forwards the data packet. For example, a rule can specify that a source address parameter of the data packet include a value in a range of values specified in the rule. If the value is outside of the specified range of values, the data packet will not be forwarded to the communication interface 508.

In another example, the network resource 102 may be configured as a network switch such as an access switch coupled to a switch fabric. For example, the network resource 102 may be an access switch configured to communicate with host devices and/or other devices (e.g., storage servers, database servers, and/or other computer servers) of service provider via a protocol, such as Ethernet through the communication ports 508, 510 and 512, and communicate with a core of a switch fabric via another protocol (for example, a cell-based protocol or other protocol other than Ethernet) through the network interface port 506. In other words, the network resource 102 may provide host devices and/or other devices configured to communicate via one protocol with access to a switch fabric configured to communication via another protocol.

More specifically, for example, the core of a switch fabric may be configured as a strictly non-blocking network or re-arrangeably non-blocking network such as a Clos network, and may include a data plane and a control plane. Thus, two host devices can be operatively coupled to one another via two network resources (each similar to the network resource 102) operatively coupled to a switch fabric. For example, a first host device can send a data packet addressed to a second host device via an Ethernet protocol to a first network resource operatively coupled to a switch fabric. The first network resource can receive the data packet and send the data packet via the switch fabric using a proprietary protocol to the second host device operatively coupled to the second network resource. For example, first network resource can send the data packet to the second network resource by separating or segmenting the data packet into cells that are transported via a cell-based switch fabric based on data signals in a data plane and a control plane of the switch fabric. Alternatively, in some embodiments the switch fabric can segment the data packet prior to transporting it to the second network resource. The second network resource may then receive the cells representing the segmented data packet, reassemble the data packet, and send the data packet to the second host device via an Ethernet protocol. Alternatively, the switch fabric can reassemble the data packet based on the cells representing the data packet prior to providing the data packet to the second network resource.

In yet another example, the network resource 102 may be configured to function as a gateway device between a switch fabric and a host device, virtual resources hosted by the host device, and/or other devices, which can be configured to transfer data based on different protocols. For example, the host device and the virtual resources hosted by the host device may be configured to communicate based on an Ethernet protocol and the switch fabric may be a cell-based fabric where one or more portions of data (e.g., data packets) are transmitted via the switch fabric in one or more cells (e.g., variable size cells, fixed size cells). In other words, the network resource 102 may provide the host device and/or other devices configured to communicate via one protocol with access to the switch fabric, which can be configured to communicate via another protocol. In some embodiments, the network resource 102 may be configured to function as a router, a network hub device, and/or a network bridge device. In some embodiments, a routing can be layer-2 switching and/or layer-3 routing. In other words, a router may be a device configured to classify and/or operate on packets at layer-2 or layer-3.

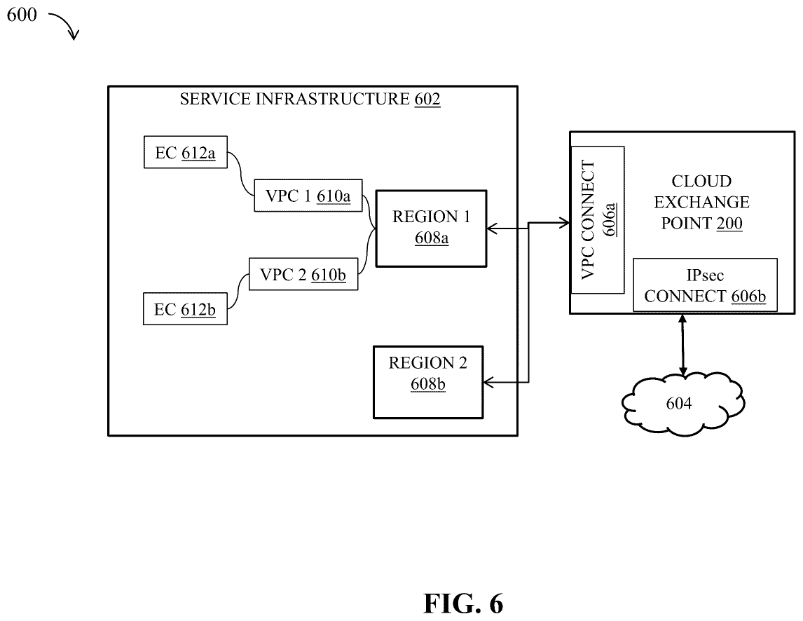

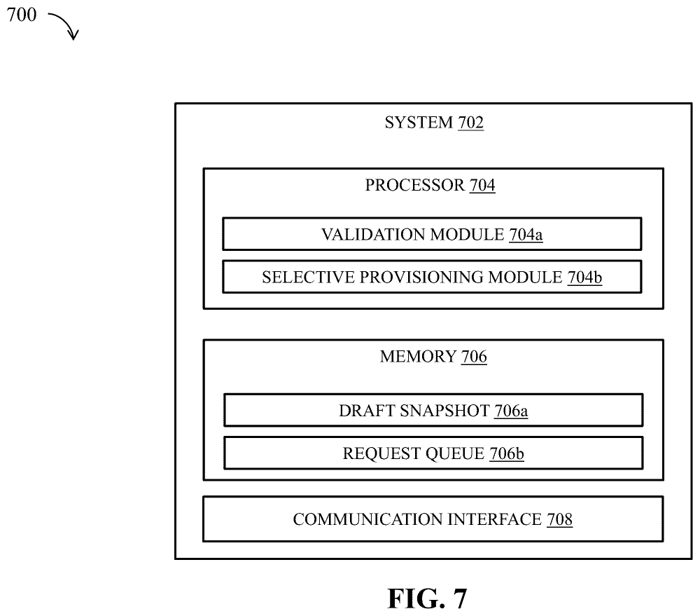

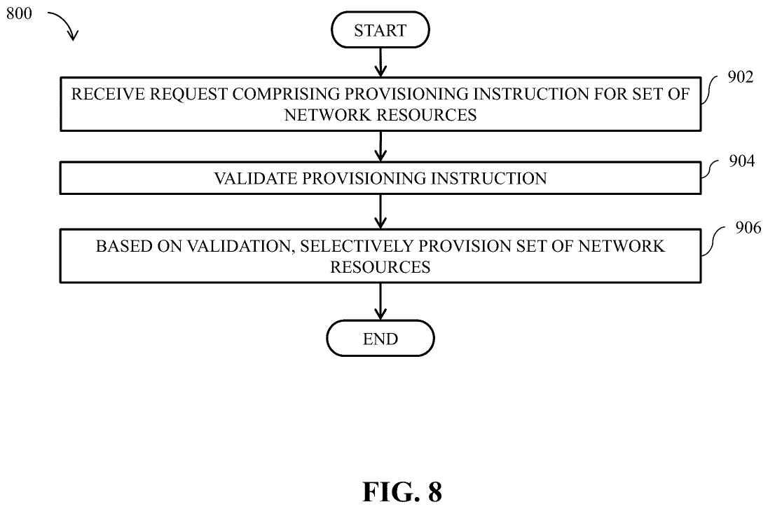

Additionally, in another example, the network resource 102 may be configured to function as a gateway device for multiple host devices. Specifically, routing functionality between virtual resources at multiple host devices may be performed at a network resource such as the network resource 102. In some embodiments, network resource 102 may include a control interface (CI) port (not shown). The CI port may be used for communicating with, for example, a network management module. For example, the network management module may be incorporated into a control plane of a network of a user or an enterprise and the network resource 102 may be operatively coupled to the control plane of the network via the CI port. For example, the network resource 102 may communicate with the network management module via the network interface port 506 and/or the communication interface ports 508, 510 and 512 to cause provisioning of the network resource 102. Details of selective provisioning of certain network resources within the network is described in detail in conjunction with following FIG. 6, FIG. 7 and FIG. 8.

FIG. 6 illustrates a block diagram 600 that shows a service infrastructure 602 connected to a network 604 of a user using the CXP 200, in accordance with an example embodiment of the present disclosure. The service infrastructure 602 may be provided by a cloud service provider. For example, the CXP 200 may include a virtual private cloud connect (VPC connect) 606a to enable the network 604 of a user or an enterprise to access a virtual private cloud (VPC) 610a and 610b offered by one or more service providers. The CXP 200 also includes a security protocol, such as an internet protocol security (IPsec) connect 606b for communicating via network path. For example, the VPC connect 606a may connect the CXP 200 to the service infrastructure 602 of one or more service providers. For example, the VPC connect 606a may be implemented as V-node 222. The service infrastructure 602 may provide services, such as SaaS, IaaS, PaaS, databases, virtual machines, containers as a service (CaaS), security services, Test/Dev environment services, virtual desktop infrastructure, etc. In an example, the network 604 may be a wired or a wireless network associated with an enterprise or an organization.

Further, the IPsec connect 606b may be a software component implemented on a configured node, such as a network resource or the network resource 102. For example, the IPsec connect 606b provides a secure network protocol suite that authenticates and encrypts packets of data to provide secure encrypted communication between two computers over an Internet Protocol network, for example, end points of the CXP 200 and the network 604 associated with the user. IPsec connect 606b may include protocols for establishing mutual authentication between agents of network resources at the beginning of a session and negotiation of cryptographic keys to use during the session. Details of the CXP 200 is described in, for example, in FIG. 2.

The service infrastructure 602 may be associated with different regions, such as a region 1 608a and a region 2 608b, for providing a service offered by same or different service providers associated with the service infrastructure 602. Further, each of the regions may include corresponding VPC for accessing a service over private cloud. The region 1 608a may provide a service via the VPC 1 610a, and the region 2 608b may provide the service via the VPC 2 610b to different enterprises, organizations, etc. over corresponding private clouds. The VPC 1 610a and the VPC 2 610b may provide network connections to compute cloud, such as elastic compute cloud depicted as EC 612a and 612b. The EC 612a and 612b are configured to provide compute capacity associated with services provided by the service provider. In addition to that, the region 1 608a and the region 2 608b may be connected or linked together using the CXP 200.

In some embodiment, the CXP 200 is utilized to exchange data between the region 1 608a and the region 2 608b. The region 1 608a and the region 2 608b may be linked together through the VPC connect 606a. The VPC connect 606a may be a networking connection facilitator that enables communication between virtual private clouds (VPCs), such as the VPC 1 610a and the VPC 2 610b. The VPC connect 606a may also facilitate routing of traffic between the VPCs 610a and 610b using private internet protocol (IP) addresses without going over internet. Further, the IPsec connect 606b may include a set of protocols and algorithm to provide secure communication over IP networks.

It may be noted, the virtual private clouds 610a and 610b may provide virtual network infrastructure that allows user, such as users associated with the network 604, to create isolated, private, and secure network environments within a public cloud provider's data center, such as within the service infrastructure 602 provided by the service provider. The VPCs 610a and 610b may enable, for example, network isolation, creating private network to place cloud resources (such as virtual machines, databases and containers), subnetting, routing, control over inbound and outbound traffic, connectivity options, etc.

FIG. 7 illustrates a block diagram 700 of a system 702 implemented for selectively provisioning of a set of network resource in the network 604, in accordance with an example embodiment of the present disclosure. The system 702 may include a processor 704 and a memory 706. Further, the processor 704 may include a validation module 704a and a selective provisioning module 704b. Furthermore, the memory 706 may store a draft snapshot 706a that indicates a saved configuration of the network 604, and a request queue 706b that stores one or more requests received from the users associated with the network 604.

The processor 704 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 704 may include one or more processing cores configured to perform independently. A multi-core processor may enable multiprocessing within a single physical package. Additionally or alternatively, the processor 704 may include one or more processors configured in tandem via the bus to enable independent execution of instructions, pipelining and/or multithreading. Additionally or alternatively, the processor 704 may include one or more processors capable of processing large volumes of workloads and operations to provide support for big data analysis. In an example embodiment, the processor 704 may be in communication with the memory 706 via a bus for passing information among components of the system 702.

In an example, when the processor 704 is embodied as an executor of software instructions, the instructions may specifically configure the processor 704 to perform the algorithms and/or operations described herein when the instructions are executed. However, in some cases, the processor 704 may be a processor specific device (for example, a mobile terminal or a fixed computing device) configured to employ an embodiment of the present disclosure by further configuration of the processor 704 by instructions for performing the algorithms and/or operations described herein. The processor 704 may include, among other things, a clock, an arithmetic logic unit (ALU) and logic gates configured to support operation of the processor 704. The network environment may be accessed using a communication interface 708 of the system 702. The communication interface 708 may provide an interface for accessing various features and data stored in the system 702.

The memory 706 may be non-transitory and may include, for example, one or more volatile and/or non-volatile memories. In other words, for example, the memory 706 may be an electronic storage device (for example, a computer readable storage medium) comprising gates configured to store data (for example, bits) that may be retrievable by a machine (for example, a computing device like the processor 704). The memory 706 may be configured to store information, data, content, applications, instructions, or the like, for enabling the system 702 to carry out various functions in accordance with an example embodiment of the present disclosure. For example, the memory 706 may be configured to buffer input data for processing by the processor 704. The memory 706 may be configured to store instructions for execution by the processor 704. As such, whether configured by hardware or software methods, or by a combination thereof, the processor 704 may represent an entity (for example, physically embodied in circuitry) capable of performing operations according to an embodiment of the present disclosure while configured accordingly. Thus, for example, when the processor 704 is embodied as an ASIC, FPGA or the like, the processor 704 may be specifically configured hardware for conducting the operations described herein.

In some example embodiments, the communication interface 708 may be wired, wireless, or any combination of wired and wireless communication networks, such as cellular, Wi-Fi, internet, local area networks, or the like. In some embodiments, the communication interface 708 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (for e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof.

In one embodiment, the processor 704 may be configured to receive one or more requests comprising corresponding provisioning instructions for provisioning of corresponding one or more sets of network resources. The one or more sets of network resources are associated with corresponding one or more service providers. In an example, a request from the one or more requests may be received from a user, such as a programmer, a system administrator, or a developer working within the network 604 of, for example, a network infrastructure of a customer of the service providers. The request may include a provisioning instruction for a set of network resources of the network 604. It may be noted that the network 604 may include a plurality of network resources, such as router, network switch, network bridge, policy, services, etc. (similar to the network resource 102). Such plurality of network resources may be provided by different service providers. To this end, each network resource from the set of the network resources associated with the received request may be associated with a corresponding particular service provider.

In an example, the provisioning instruction may include instructions for provisioning of the set of network resources of the network 604. For example, the user may configure, i.e., generate architecture for the set of network resources of the network 604 and submit the request to the system 702. The request received from the user may include configurations for the set of network resources that are to be changed, modified, added or removed in the network 604. Typically, the system 702 may receive multiple requests from different users, wherein the different requests may be associated with provisioning of different sets of network resources of the network 604 in the network infrastructure of an enterprise or the customer. For example, different sets of network resources are associated with different service providers providing services to the enterprise. For example, a first user may request to provision a first set of network resource, and a second user may request to provision a second set of network resources, and so on.

Continuing further, the validation module 704a of the processor 704 may be configured to validate the received provisioning instruction of the request relating to the set of network resources based on the draft snapshot 706a relating to the set of network resources. For example, the provisioning instruction received from the user may have a desired configuration relating to the set of network resources. The provisioning instruction is validated by the validation module 704a to ensure that integrity of the network 604 is maintained during the provisioning of the set of network resources.

In an example, based on the validation, the selective provisioning module 704b of the processor 704 may be configured to cause selectively provisioning of the set of network resources from the plurality of network resources of the network 604 based on the provisioning instruction of the request. For example, the selective provisioning may be performed by pushing the provisioning instruction to an orchestration engine where the selective provisioning is performed by the selective provisioning module 704b. Further, the selective provisioning of the set of network resources is performed based on service provider data of the service provider associated with the request.

For example, a first user may place a request relating to provisioning of a first set of network resources relating to a first service provider, for example, service provider ‘A’; and a second user may place a request relating to provisioning of a second set of network resources relating to a second service provider, for example, service provider ‘B’. Further, based on technical expertise of a network designer and/or the network administrator, say the network administrator has expertise for the first service provider ‘A’, the selective provisioning of the first set of network resources associated with the first service provider ‘A’ may be performed. To this end, different network resources of the network 604 that may be relating to different service providers may be provisioned separately, for example, during different time periods to ensure that integrity of the network 604 is maintained and the network 604 is not incorrectly provisioned.

Further, the processor 704 is configured to output a network architecture of the network 604. The network architecture may indicate a node-level view of the set of network resources that have been provisioned. The node-level view of the provisioned set of network resources, say the first set of network resources may include updated provisioning information indicating updated status, policies, and/or rules for operation of the first set of network resources.

In some embodiments, the processor 704 is further configured to cause selective provisioning of different provisioning instructions relating to different sets of network resources and/or different service providers during different time periods. As afore explained, based on the availability of a network administrator having expertise or knowledge of a particular service provider, or a provisioning module equipped with service provider data of the particular service provider for automated provisioning, the provisioning of a set of network resources associated with the particular service provider may be performed.

In some embodiments, the processor 704 may be configured to generate an architecture of the set of network resources based on the provisioning instruction for the set of network resources. Further, the processor 704 may capture a current snapshot of the generated architecture for the set of network resources. Further, based on the draft snapshot 706a indicating a previous draft version or architecture of the set of network resources, the processor 704 may be configured to validate an integrity of the provisioning instruction for the set of network resources by overlaying the current snapshot over the draft snapshot.

In accordance with an example embodiment, the processor 704 may be configured to identify one or more configuration changes for the set of network resources based on the overlaying of the current snapshot over the draft snapshot. Further, after the validation, the processor 704 or the selectively provisioning module 704b may be configured to cause the selective provisioning of the set of network resources, such as the network resource 102 of the network 604 based on the one or more configuration changes.

In an example, draft snapshot 706a may include a snapshot of previous draft versions or architectures of different sets of network resources of the network 604. The draft snapshot 706a may refer to an image indicating a previous or existing configuration or provisioning of the set of network resources of the network 604 that is to be changed or updated. The draft snapshot 706a of the set of network resources of the network 604 is utilized by the system 702 to perform the provisioning of the set of network resources.

Further, in some embodiments, the memory 706 may be a read only memory (ROM) or a random access memory (RAM). The memory 706 may be non-transitory and may include, for example, one or more volatile and/or non-volatile memories. The memory 706 of the system 702 may be configured to store a dataset associated with provisioning of the network 604. In accordance with an embodiment, the memory 706 may include processing instructions for processing the provisioning instruction or the request. The dataset may include real-time data and historical data associated with provisioning of the network 604. Further, the memory may store one or more requests received from one or more users associated with the network 604.

In some embodiments, the processor 704 may be configured to generate the request queue 706b for storing one or more requests for provisioning of one or more sets of network resources associated with the network 604 or network infrastructure of, for example, an enterprise, an organization or a user. The one or more sets of network resources may be associated with corresponding one or more service providers. Further, the request queue 706b may indicate a status for each of the one or more requests. Further, the generated request queue 706b may be stored in the memory 706. The request queue 706b may include the provisioning instructions that are part of the one or more requests that need to be provisioned by a network administrator or different network administrators associated with the one or more service providers. The request queue 706b may have a status symbol that shows a current status or progress of all of the one or more requests stored in the request queue 706b. For example, when the one or more requests in the request queue 706b are pending, then all coming requests for provisioning may be stored in the request queue 706b and status of the request queue 706b may be indicated as “pending”. Further, if any one of the one or more requests from the request queue 706b is initiated for provisioning, then status of the request queue 706b may be changed from “pending” to “in-progress” and no new request may be added to the request queue 706b.

For example, the status may indicate: pending provisioning, in progress provisioning, provisioning completed and/or provisioning denied. A request submitted and stored in the request queue 706b as well as the request queue 706b itself may have pending status initially. Further, the provisioning instructions relating to the one or more requests received from the users at different time instants is stored in the request queue 706b until the status of the corresponding request turns to in-progress or completed. To this end, if one or more requests in the request queue 706b are in progress, i.e., provisioning based on the one or more requests is in progress, and then any request received after a change in the status of the request queue 706b from pending to in progress is stored in a new request queue.

FIG. 8 illustrates a method flowchart 800 for selectively provisioning of the set of network resources of the network 604, in accordance with an example embodiment of the present disclosure. In an example, the processor 704 may be configured to selectively provision a portion of the network 604, by provisioning only the set of network resources.

In this regard, at 802, a request comprising a provisioning instruction for the set of network resources of the network 604 is received. The network may include a plurality of network resources. Further, the set of the network resources from the plurality of network resources is associated with a service provider. For example, the processor 704 may receive one or more requests comprising a corresponding provisioning instruction relating to one or more different sets of network resources. Such one or more requests may be stored in the request queue 706b.

At 804, the provisioning instruction relating to the set of network resources is validated. For example, the processor 704 or the validation module 704a may validate the provisioning instruction of the request by overlaying the draft snapshot 706a relating to the set of network resources on an image of an architecture indicated in the provisioning instruction.

Once the provisioning instruction is validated, at 806, the set of network resources from the plurality of network resources of the network 604 is selectively provisioned based on the provisioning instruction. For example, the selective provisioning of the set of network resources of the network 604 is performed based on service provider data of a service provider associated with the request. For example, the service provider data may include a manual or instructions on how to provision network resources relating to the service provider, functionality relating to different network resources, etc. Therefore, based on the service provider data relating to the particular service provider associated with the request, the selective provisioning of only the set of network resources associated with the service provider is performed. In this manner, the set of network resources may be provisioned reliably.

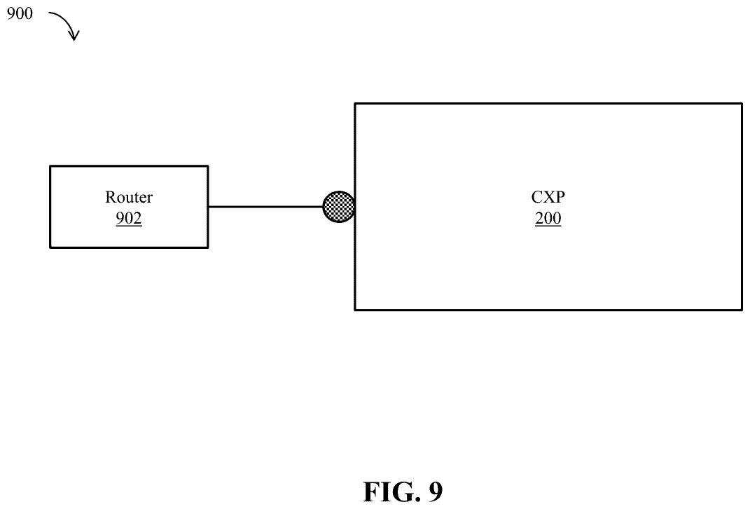

FIG. 9 illustrates an example network architecture 900 for a network of an enterprise, in accordance with an example embodiment. In an example, the network architecture 900 includes a network resource 902, i.e., a router 902, connected to a cloud exchange point (CXP) 200. In particular, the network architecture 900 may be an initial configuration of the network of the enterprise or an organization.

For example, the router 902 may be a networking device that connects different networks together, such as a local area network (LAN) to the internet or multiple LANs. To this end, the router 902 may connect a LAN of the enterprise to a cloud platform of a cloud service provider using the cloud exchange point (CXP) 200. The router 902 is configured to enable or perform, for example, packet forwarding using protocols (such as border gateway protocol, etc.), network address translation to allow multiple devices on a local network to share a single public IP address, firewall to filter incoming and outgoing traffic based on predefined rules, etc. To this end, the router 902 may enable the routing of data between the network of the enterprise and/or devices in the enterprise network, and the CXP 200 for using services provided or hosted at a cloud service provider.

Further, the CXP 200 may be a physical location where multiple cloud service providers (CSPs) and other network service providers are interconnect with the network of the enterprise or the organization. The CXP 200 may enable direct cloud connectivity to provide a way for the network of the enterprise (referred to as enterprise network, hereinafter) to connect directly to multiple cloud service providers without traversing the public internet. In particular, the CXP 200 may facilitate direct, high-performance connections between the enterprise network or the router 902 and one or more cloud service providers, thereby optimizing the delivery of cloud-based services and reducing latency and costs.

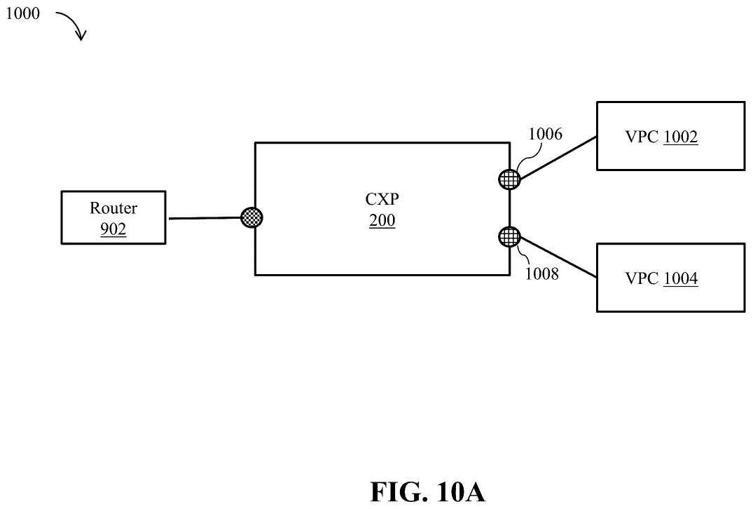

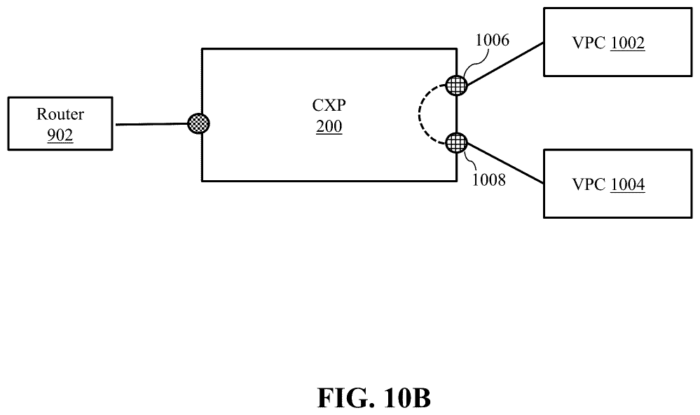

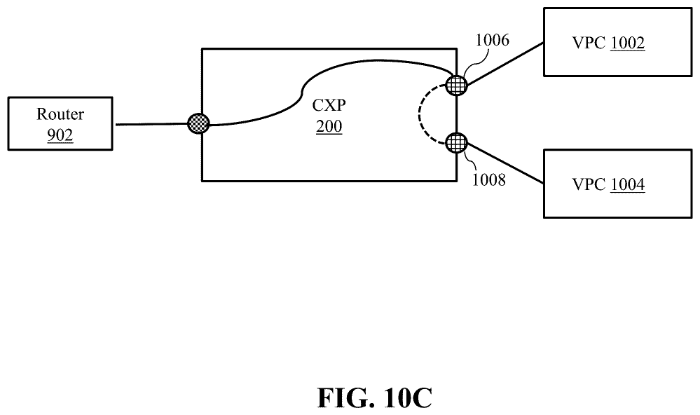

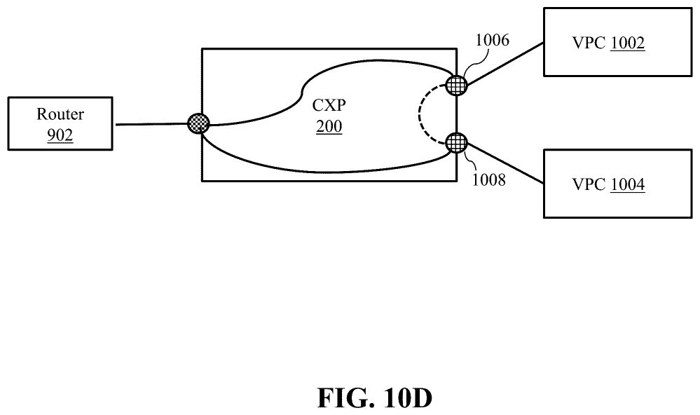

For example, as the router 902 is connected to the CXP 200, users of the enterprise network at the given router 902 can access services, such as applications that would be hosted, made available or provided by cloud service providers accessible via the CXP 200. A manner in which provisioning of network resources for making a service accessible via a cloud service provider is described in detail in conjunction with FIGS. 10A, 10B, 10C and 10D.

FIGS. 10A, 10B, 10C and 10D collectively illustrate an example process of selective provisioning of network resources, in accordance with an example embodiment of the present disclosure. In an example, the router 902 may connect the network of an enterprise with the CXP 200, in order to enable users of the network to use services hosted at a cloud service platform.

Pursuant to present example, the users of the enterprise network associated with the router 902 may have to access or make available a service, such as an application, hosted at a first service provider, such as via a first VPC 1002, and access or make available another service or application hosted at a second service provider, such as via a second VPC 1004. In certain cases, the users of the network may create and host such services at the first VPC 1002 and the second VPC 1004. In certain other cases, the users of the network may be merely users of applications hosted via the first VPC 1002 and the second VPC 1004.

In an example, certain users, such as network engineers, of the enterprise network may define a manner in which the first VPC 1002 and the second VPC 1004 needs to be provisioned to become available for use to other users of the enterprise network or other users of other networks. To this end, for example, a user A may provide a first request associated with the provisioning of the first VPC 1002 and a user B may provide a second request associated with the provisioning of the second VPC 1004. The first request may include provisioning instructions (such as configuration of connectors) regarding the provisioning of the first VPC 1002, whereas the second request may include provisioning instructions (such as configuration of connectors) regarding the provisioning of the second VPC 1004. Once the requests are generated, a network administrator may have to provision the first VPC 1002 and the second VPC 1004.

In this regard, at first, the first request and the second request may be validated based on a draft snapshot of the network or current provisioning of the first VPC 1002 and the second VPC 1004. Once validated, the first request and the second request may be added to a request queue for provisioning.

Further, during the provisioning, a network administrator may selectively provision network resources associated with the first VPC 1002 and the second VPC 1004.

Referring to 10A, based on the first request and the second request, a network entity may be added to a network configuration 1000. In particular, connectors 1006 and 1008 or policy may be added to the network configuration. For example, the connectors may be configured to join or connect various components together. They serve as interfaces that enable the transmission of electrical signals, data, power, or other forms of communication between connected elements. Moreover, policies may be added based on desired network configurations.

Referring to FIG. 10B, the network administrator may configure a traffic policy that disallows any communication between the first VPC 1002 and the second VPC 1004. To this end, if the first request and the second request are still not validated and/or the validation fails, then such provisioning may fail, however, if the first request and/or the second request are validated then provisioning of the first VPC 1002 and the second VPC 1004 continues.

Referring to FIG. 10C, the first request is provisioned. In particular, once the first request is validated, the network configuration can be provisioned based on the first request. In this regard, a network administrator may provision changes based on the provisioning instructions indicated in the first request to the network configuration of a network resource indicated in the first request. In an example, the first request is associated with the first VPC 1002. Subsequently, the network administrator may provision changes in the first VPC 1002.

For example, the system of present disclosure allows the network administrator to provision only the first request, such as by provisioning the changes of the first request. Although the present disclosure described provisioning of the first request and the second request separately, however, this should not be construed as a limitation. In certain cases, the first request and the second request may be provisioned together.

Continuing further, the first request relating to the first VPC 1002 may require the provisioning of the connector 1006. To this end, when the connector 1006 is selected, for example, by the network administrator, the connector 1006 may be provisioned such that the router 902 is connected to the first VPC 1002 via the CXP 200 and the connector 1006. At the provisioning step, the change is actually deployed in the configuration to the CXP 200.

Referring to FIG. 10D, the second request is provisioned. In particular, once the first request is provisioned and the second request is validated, the network configuration can be provisioned based on the second request. In this regard, a network administrator may provision changes based on the provisioning instructions indicated in the second request to the network configuration of a network resource associated with the second VPC 1004. In an example, the second request is associated with the second VPC 1004. Subsequently, the network administrator may provision changes in the second VPC 1004.

Further, the second request relating to the second VPC 1004 may require the provisioning of the connector 1008. To this end, when the connector 1008 is selected, for example, by the network administrator, the connector 1008 may be provisioned such that the router 902 is connected to the second VPC 1004 via the CXP 200 and the connector 1008. At the provisioning step, the change is actually deployed in the network configuration to the CXP 200. Once the changes in the network configuration are provisioned, the services hosted at the first VPC 1002 and the second VPC 1004 may go live.

For example, the diagram in the FIG. 10D, may show the provisioned state of the network configuration. The network configuration includes the router 902, such as IPSec on a branch side to the network side of the enterprise and the first VPC 1002 and the second VPC 1004 on cloud side. Using the system for selective provisioning, the network administrator may provision a manner in which traffic flows between the router 902 and the first VPC 1002, or the router 902 and the second VPC 1004. In certain cases, traffic may also flow between the first VPC 1002 and the second VPC 1004, if needed, but a mechanism to restrict such traffic flow is implemented in the present network configuration based on a traffic policy. The traffic policy is only exemplary.

Based on the provisioned state of the network configuration shown in the FIG. 10D, the network may have fully established connectivity and traffic is flowing. It may be noted that, such example representation of the network configuration is only exemplary. Further, in practical applications, a large number of branches and VPCs may be present such that the branches and VPCs may span multiple CXPs as well. Therefore, using the system for selective provisioning the network configuration is created for organizations and enterprises hosting applications and/or accessing applications on multiple of VPCs incrementally by adding connectors, services and policies over time.

Further, while creating and provisioning the network resources selectively using the system for selective provisioning, integrity of the network is maintained. One part of ensuring integrity is to ensure that when one network entity or network resource ‘A’ is dependent on another network entity or network resource ‘B’ then any changes to the network resource ‘B’ should not result in the invalidation of the configuration of network resource ‘A’. For example, in the above network configuration, connectors 1006 or 1008 cannot be deleted because it will make the network configuration invalid. To this end, if the network administrator choses to provision the policy of restricted traffic flow between the connectors 1006 and 1008 without provisioning of the first request and/or the second request, then such configuration may affect network integrity. For example, such configuration may not be validated or allowed to ensure network integrity.

In this manner, users or network administrators are offered the choice to provision only a subset of the configured network, or entire network based on the received requests of provisioning. Moreover, the integrity of the provisioned network is ensured while allowing selective provisioning of the network entities. The system and the method are provided herein focuses on selective provisioning of a portion of the network or certain network resources of the network. More particular the system and the method disclosed herein enables a user to selectively provision a portion of the network or network resources of the portion of the network while maintaining integrity of the network. The selective provisioning of the network may be considered as an advance way of provisioning network resources for ensuring connectivity as well as acquire services (such as firewall, VPN, or the like) on a per-user request or per-application basis. The selective provisioning of the one or more network resources of the network is very important in ensuring integrity of provisioning, optimizing network performance, reducing latency, and ensuring that the all the components or entities involved in networking function properly.

Accordingly, blocks of the flowchart 800 support combinations of means for performing the specified functions and combinations of operations for performing the specified functions. It will also be understood that one or more blocks of the flowchart 800, and combinations of blocks in the flowchart 800, can be implemented by special purpose hardware-based computer systems which perform the specified functions, or combinations of special purpose hardware and computer instructions.

Alternatively, the system 702 may comprise means for performing each of the operations described above. In this regard, according to an example embodiment, examples of means for performing operations may comprise, for example, the processor 704 and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A system comprising:
a memory configured to store computer executable instructions; and
one or more processors are configured to execute the instructions to:
receive a request comprising a provisioning instruction for a set of network resources of a network, the network comprising a plurality of network resources, wherein the set of the network resources from the plurality of network resources is associated with a service provider;
validate the provisioning instruction relating to the set of network resources based on a draft snapshot relating to the set of network resources; and
based on the validation, cause to selectively provision the set of network resources from the plurality of network resources of the network based on the provisioning instruction, wherein the selective provisioning of the set of network resources is performed based on service provider data of the service provider associated with the set of network resources.

2. The system of claim 1, wherein the one or more processors are further configured to:
based on the selective provisioning, output a network architecture indicating a node-level view of the set of network resources having updated provisioning information.

3. The system of claim 1, wherein the network provides a service including at least one of: a software as a service (SaaS), an infrastructure as a service (IaaS), a platform as a service (PaaS), or a virtual network.

4. The system of claim 1, wherein the one or more processors are further configured to:
generate an architecture of the set of network resources based on the provisioning instruction;
capture a current snapshot of the generated architecture; and
based on a previous draft snapshot of the set of network resources, validate an integrity of the provisioning instruction for the set of network resources by overlaying the current snapshot over the draft snapshot.

5. The system of claim 4, wherein the one or more processors are further configured to:
identify one or more configuration changes for the set of network resources based on the overlaying of the current snapshot over the draft snapshot; and
based on the validation and the one or more configuration changes, selectively provision the set of network resources of the network.

6. The system of claim 1, wherein the one or more processors are further configured to:
receive one or more requests comprising corresponding provisioning instructions for corresponding one or more sets of network resources, the one or more sets of network resources being associated with corresponding one or more service providers;
generate a request queue for storing the one or more requests, the request queue indicating a status for each of the one or more requests.

7. The system of claim 6, wherein the one or more processors are further configured to:
cause selective provisioning of the provisioning instructions of the one or more requests during different time periods.

8. A method comprising:
receiving a request comprising a provisioning instruction for a set of network resources of a network, the network comprising a plurality of network resources, wherein the set of the network resources from the plurality of network resources is associated with a service provider;
validating the provisioning instruction relating to the set of network resources based on a draft snapshot relating to the set of network resources; and
based on the validation, causing to selectively provision the set of network resources from the plurality of network resources of the network based on the provisioning instruction, wherein the selective provisioning of the set of network resources is performed based on service provider data of the service provider associated with the set of network resources.

9. The method of claim 8, further comprising:
outputting a network architecture indicating a node-level view of the set of network resources having updated provisioning information based on the selective provisioning.

10. The method of claim 8, wherein the network provides a service including at least one of: a software as a service (SaaS), an infrastructure as a service (IaaS), a platform as a service (PaaS), or a virtual network.

11. The method of claim 8, further comprising:
generating an architecture of the set of network resources based on the provisioning instruction;
capturing a current snapshot of the generated architecture; and
based on a previous draft snapshot of the set of network resources, validating an integrity of the provisioning instruction for the set of network resources by overlaying the current snapshot over the draft snapshot.

12. The method of claim 11, further comprising:
identifying one or more configuration changes for the set of network resources based on the overlaying of the current snapshot over the draft snapshot; and
based on the validation and the one or more configuration changes, selectively provisioning the set of network resources of the network.

13. The method of claim 8, further comprising:
receiving one or more requests comprising corresponding provisioning instructions for corresponding one or more sets of network resources, the one or more sets of network resources being associated with corresponding one or more service providers;
generating a request queue for storing the one or more requests, the request queue indicating a status for each of the one or more requests.

14. The method of claim 13, further comprising:
causing selective provisioning of the provisioning instructions of the one or more requests during different time periods.

15. A machine-readable medium storing computer-executable instructions that, when executed by one or more processors, cause the one or more processors to perform a method comprising:
receiving a request comprising a provisioning instruction for a set of network resources of a network, the network comprising a plurality of network resources, wherein the set of the network resources from the plurality of network resources is associated with a service provider;
validating the provisioning instruction relating to the set of network resources based on a draft snapshot relating to the set of network resources; and
based on the validation, causing to selectively provision the set of network resources from the plurality of network resources of the network based on the provisioning instruction, wherein the selective provisioning of the set of network resources is performed based on service provider data of the service provider associated with the set of network resources.

16. The machine-readable medium of claim 15, wherein the set of network resources comprises at least one of: a router, a switch, a firewall, a virtual machine, or a database.

17. The machine-readable medium of claim 15, wherein validating the provisioning instruction comprises checking the provisioning instruction against predefined policies or rules.

18. The machine-readable medium of claim 17, wherein validating the provisioning instruction further comprises comparing the provisioning instruction with historical data or previous configurations.

19. The machine-readable medium of claim 15, wherein the draft snapshot includes metadata comprising at least one of: a timestamp, a version number, or an author.

20. The machine-readable medium of claim 19, wherein the draft snapshot is stored in a format selected from the group consisting of JSON and XML.
